(19) United States
(12) Patent Application Publication
(10) Pub. No.: US 2025/0012571 A1
(43) Pub. Date: Jan. 9, 2025

(54) Sensor Apparatus

(71) Applicant: Sumitomo Precision Products Co., Ltd., Amagasaki-shi (JP)

(72) Inventors: Hideyuki DOYAMA, Amagasaki-shi (JP); Ryohei UCHINO, Amagasaki-shi (JP)

(21) Appl. No.: 18/889,504

(22) Filed: Sep. 19, 2024

Related U.S. Application Data
(63) Continuation of application No. PCT/JP2023/010898, filed on Mar. 20, 2023.

(30) Foreign Application Priority Data
Mar. 28, 2022 (JP) 2022-052372

(51) Int. Cl. G01C 19/00

(52) U.S. Cl. CPC G01C 19/00

(57) ABSTRACT

A sensor apparatus (100) according to this invention includes a plurality of sensor sets (10), each set including a plurality of different types of sensors; and a common sensor arrangement part (1) to which the plurality of sensor sets (10) are provided, wherein the plurality of sensor sets (10) include at least one type of sensors that measure a common type of physical quantities and are identical to each other in design, and the at least one type of sensors that are identical to each other in design are arranged symmetric with respect to a center of gravity of the sensor arrangement part (1).

### CROSS-REFERENCE TO RELATED APPLICATION

This application is a continuation of PCT application PCT/JP2023/010898, filed on Mar. 20, 2023, claiming a priority of Japanese Patent Application No. 2022-052372 filed on Mar. 28, 2022, the disclosure of which is incorporated herein.

### BACKGROUND OF THE INVENTION

### Field of the Invention

The present invention relates to a sensor apparatus, and particularly to a sensor apparatus including a sensor arrangement part on or above a sensor is arranged.

### Description of the Background Art

Sensor apparatuses including a sensor arrangement part on or above a sensor is arranged are known in the art. Such a sensor apparatus is disclosed in Japanese Patent Laid-Open Publication No. JP 2021-67625, for example.

The inertial measurement device (sensor apparatus) stated in Japanese Patent Laid-Open Publication No. JP 2021-67625 includes a printed circuit board (sensor arrangement part) to which the sensors are provided. The aforementioned sensors include a plurality of gyroscopes corresponding to X, Y and Z axes, which are perpendicular to each other. Here, although not explicitly stated in Japanese Patent Laid-Open Publication No. JP 2021-67625, the sensor apparatus includes a plurality of sensor sets, which include an X-axis gyroscope, a Y-axis gyroscope and a Z-axis gyroscope in each set, to provide a backup set of sensors (to provide redundancy) in some cases.

Japanese Patent Laid-Open Publication No. JP 2021-67625 discloses a plurality of sensor sets, which include an X-axis gyroscope, a Y-axis gyroscope and a Z-axis gyroscope in each set, to provide a backup set of sensors (to provide redundancy) in some cases. In such a case, it is considered that sensor arrangement parts corresponding to the plurality of sensor sets are provided separately from each other. For this reason, the number of parts of the sensor apparatus increases, and the sensor apparatus has a complicated structure.

### SUMMARY OF THE INVENTION

The present invention is intended to solve the above problem, and one object of the present invention is to provide a sensor apparatus capable of reducing the number of parts and preventing its structure from becoming complicated even in a case in which a plurality of sets of sensors are provided.

In order to attain the aforementioned object, a sensor apparatus according to an aspect of the present invention includes a plurality of sensor sets, each set including a plurality of different types of sensors; and a common sensor arrangement part to which the plurality of sensor sets are arranged, wherein the plurality of sensor sets include at least one type of sensors that measure a common type of physical quantities and are identical to each other in design, and the at least one type of sensors that are identical to each other in design are arranged symmetric with respect to a center of gravity of the sensor arrangement part.

In the sensor apparatus according to the aspect of the present invention, as discussed above, a common sensor arrangement part to which the plurality of sensor sets are provided is included. Accordingly, it possible to reduce the number of parts of the sensor apparatus, and to prevent a configuration of the sensor apparatus from becoming complicated as compared to a case in which sensor arrangement parts corresponding to the plurality of sensor sets are provided separately from each other.

Also, in a case in which a plurality of sensor arrangement parts are provided, a gap is necessarily provided between the sensor arrangement parts to prevent interference of the sensor arrangement parts. Contrary to this, in the case in which the plurality of sensor sets are provided to the common sensor arrangement part, the aforementioned gap can be omitted so that an installation (arrangement) area of the common sensor arrangement part can be reduced.

Also, in the case in which the sensor arrangement parts corresponding to the plurality of sensor sets are provided separately from each other, position misalignment between the sensor arrangement parts may occur. In this case, the misalignment between the sensor sets may be large. From this viewpoint, no position misalignment between the sensor arrangement parts occurs in a case of the common sensor arrangement part to which the plurality of sensor sets are provided, and as a result, it is possible to prevent the position misalignment between the sensor sets. Consequently, it is possible to reduce difference between detection results of the sensor sets caused by the aforementioned position misalignment.

In the sensor apparatus according to the aforementioned aspect, it is preferable that the sensor arrangement part has a polyhedral shape; that the sensor arrangement part includes recessed parts for arranging all of the sensors that are arranged symmetric with respect to the center of gravity; and that the recessed parts are opened in directions perpendicular to any surface of the sensor arrangement part. According to this configuration, a protrusion amount of the sensor from the sensor arrangement part can be reduced by at least a depth of the recessed part by arranging the sensor in the recessed part. Consequently, it is possible to further reduce size of the sensor apparatus.

In this configuration, it is preferable that each of the plurality of sensor sets includes corresponding first-axis sensors, corresponding second-axis sensors and corresponding third-axis sensors corresponding a first axis, a second axis and a third axis, respectively, perpendicular to each other as the sensors that are arranged symmetric with respect to the center of gravity; and the sensor arrangement part has a rectangular parallelepiped shape; and that all of the first-axis sensors, all of the second-axis sensors, and all of the third-axis sensors are arranged in the recessed parts of the sensor arrangement part. According to this configuration, a protrusion amount of the sensor from the sensor arrangement part can be reduced by at least a depth of the recessed part by arranging all of the first-axis sensors, all of the second-axis sensors, and all of the third-axis sensors in the recessed parts. Consequently, it is possible to further reduce size of the sensor apparatus.

In this configuration, it is preferable that a controller is further provided; that the first-axis sensors, the second-axis sensors and the third-axis sensors included in the plurality of sensor sets include at least one pair of sensors that are paired to face each other; and that the controller receives measurement results from both the pair of sensors, and executes control of reversing polarity of measured values included in one of the measurement results and control of not reversing polarity of measured values included in another of the measurement results. According to this configuration, even if an abnormality occurs in one of the pair of sensors, a detection value of another of the pair of sensors can be used.

In this configuration, it is preferable that at least one pair of the first-axis sensors are arranged rotational symmetric with respect to an axis line that passes through the center of gravity of the sensor arrangement part and extends in a predetermined direction; that at least one pair of the second-axis sensors are arranged rotational symmetric with respect to the axis line, which passes through the center of gravity of the sensor arrangement part and extends in the predetermined direction; and that at least one pair of the third-axis sensors are arranged rotational symmetric with respect to the axis line, which passes through the center of gravity of the sensor arrangement part and extends in the predetermined direction. According to this configuration, since absolute values of detection values of the first-axis sensors can be the same, even if an abnormality occurs in one of the pair of first-axis sensors, a detection value of another of the pair of first-axis sensors can be used. The second-axis sensors and the third-axis sensors have a similar advantage to the first-axis sensors.

In the aforementioned sensor apparatus in which the paired-axis sensors are arranged rotational symmetric with respect to the axis line, it is preferable that the axis line extends perpendicular to a bottom surface of the sensor arrangement part. According to this configuration, the first-axis sensors can be easily arranged symmetric with respect to the axis line extending perpendicular to the bottom surface of the sensor arrangement part. The second-axis sensors and the third-axis sensors have a similar advantage to the first-axis sensors.

In this configuration, it is preferable that the pair of first-axis sensors are arranged on each of a pair of first surfaces on sides of the sensor arrangement part opposite to each other; the pair of second-axis sensors are arranged on each of a pair of second surfaces on sides of the sensor arrangement part opposite to each other; and that the pair of third-axis sensors are arranged on a common third surface of the sensor arrangement part. According to this configuration, it is possible to easily reduce an area of the first surface (second surface) as compared with a case in which the first-axis sensors are arranged in a common first surface (the second-axis sensors are arranged in a common second surface). Consequently, it is possible to easily reduce size of the sensor arrangement part (sensor apparatus). Also, dissimilar to a case where the pair of third-axis sensors are arranged in opposite-side surfaces of the sensor arrangement part, the sensors are not arranged on a surface opposite to the third surface. Accordingly, it is possible to easily arrange a part (board, wiring part, or the like) other than the sensors in a surface opposite to the third surface. These arrangements allow easy arrangement of parts (boards, wiring parts, and the like) other than the sensors while reducing size of the sensor arrangement part (sensor apparatus).

In this configuration, it is preferable that centerlines extending in a depth direction of the recessed parts that are opened in the surfaces of the sensor arrangement part and paired for the pair of the first-axis sensors in the plurality of sensor sets disagree with each other and extend in parallel to each other; that centerlines extending in a depth direction of the recessed parts that are opened in the surfaces of the sensor arrangement part and paired for the pair of the second-axis sensors in the plurality of sensor sets disagree with each other and extend in parallel to each other; and that centerlines extending in a depth direction of the recessed parts that are opened in the surface of the sensor arrangement part and paired for the pair of the third-axis sensors in the plurality of sensor sets disagree with each other and extend in parallel to each other.

In the sensor apparatus according to the aforementioned aspect, it is preferable that the first-axis, second-axis and third-axis sensors are gyroscopes. Here, the gyroscopes are relatively large sensors as compared with, for example, acceleration sensors. For this reason, in the case in which the sensor arrangement parts corresponding to the plurality of sensor sets are provided separately from each other, a plurality of relatively large sensor arrangement parts are provided. From this viewpoint, in a case in which the sensors include gyroscopes, prevention of increase of the number of sensor arrangement parts by arranging the plurality of sensor sets in the common sensor arrangement part is particularly effective at reducing size of the sensor apparatus.

### Effect of the Invention

According to the present invention, it possible to reduce the number of parts of the sensor apparatus, and to prevent a configuration of the sensor apparatus from becoming complicated even in the case in which a plurality of sensor sets are provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view entirely showing a sensor apparatus according to one embodiment.

FIG. 2 is an exploded perspective view showing a sensor mount, and control and power supply boards according to the one embodiment.

FIG. 3 is an exploded perspective view showing the sensor mount, gyroscopes, and plates according to the one embodiment.

FIG. 4 is a perspective view of the sensor mount according to the one embodiment as diagonally viewed from a lower side.

FIG. 5 is a block diagram showing a configuration of a sensor apparatus according to the one embodiment.

FIG. 6 is a schematic sectional view showing a relation between a connection wiring part and a cut-out part in the one embodiment.

FIG. 7 is a perspective view showing a configuration of the gyroscope according to the one embodiment.

### MODES FOR CARRYING OUT THE INVENTION

### Description of the Preferred Embodiments

Embodiments according to the present invention will be described with reference to the drawings.

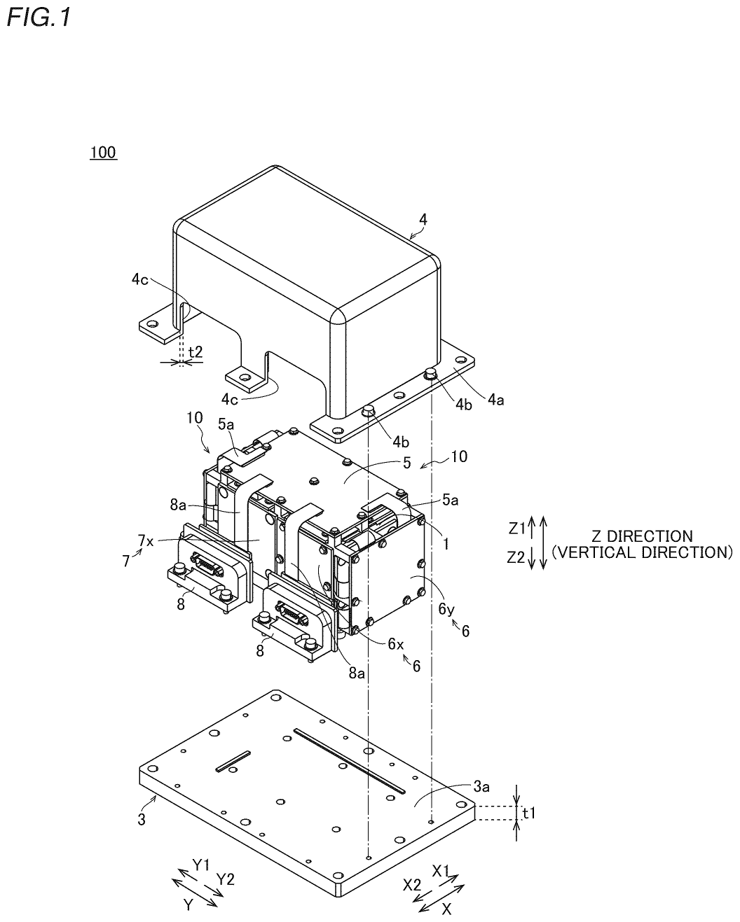

A sensor apparatus 100 according to one embodiment is first described with reference to FIGS. 1 to 7.

### (Entire Configuration of Sensor Apparatus)

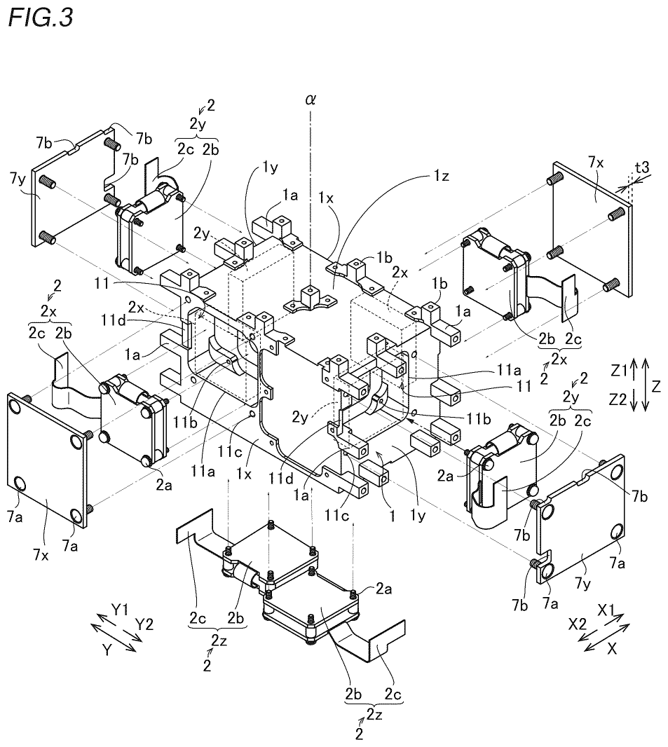

As shown in FIG. 1, the sensor apparatus 100 includes a sensor mount 1, gyroscopes 2 (see FIG. 3), a base 3, a cover 4, a power supply board 5, control boards 6 and plates 7. Here, the sensor mount 1 and the gyroscope 2 are an example of a “sensor arrangement part” and an example of a “sensor”, respectively, in the claims.

Two connectors 8 for connecting to the power supply board 5 to an external power supply (not shown) and for transmitting/receiving signals are attached to the sensor mount 1. The connectors 8 are connected to the power supply board 5 through flexible cables 8a. The flexible cables 8a are provided to the sensor apparatus 100 with being bent. Any of FPC (Flexible printed Circuit) and FFC (Flexible Flat Cable) can be used as the flexible cables 8a.

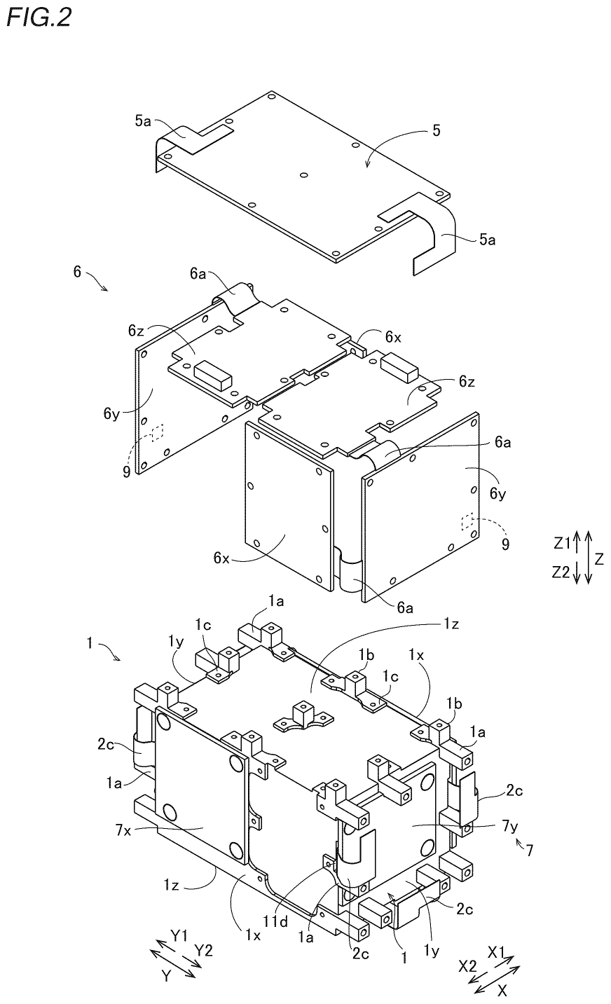

The sensor mount 1 has a polyhedral shape, as shown in FIG. 2. Specifically, the sensor mount 1 has rectangular parallelepiped shape. Also, the sensor mount 1 includes a pair of X-axis surfaces 1x, which extend perpendicular to an X axis, a pair of Y-axis surfaces 1y, which extend perpendicular to a Y axis, and a pair of Z-axis surfaces 1z, which extend perpendicular to a Z axis. Here, the X-axis surfaces 1x are examples of a “first surface” and a “pair of surfaces” in the claims. Also, the Y-axis surfaces 1y are examples of a “second surface” and the “pair of surfaces” in the claims. Also, the Z-axis surface 1z on a Z2 side of the pair of Z-axis surfaces 1z is an example of a “third surface” and an example of a “bottom surface” in the claims. Also, the X-axis is an example of a “first axis” in the claims. Also, the Y-axis is an example of a “second axis” in the claims. Also, the Z-axis is an example of a “third axis” in the claims. Here, in this embodiment, the Z axis is an axis that extends in a vertical direction.

The sensor mount 1 includes a plurality of Y-axis protrusions 1a which are arranged on each of the pair of Y-axis surfaces 1y to protrude from the Y-axis surfaces 1y. The Y axis control boards 6y described later are connected (fastened) to the Y-axis protrusions 1a.

Also, the sensor mount 1 includes a plurality of Z-axis protrusions 1b which are arranged on the Z-axis surface 1z on the Z1 side to protrude from the Z-axis surface 1z. The power supply board 5 is connected (fastened) to the Z-axis protrusions 1b. Also, the sensor mount 1 includes a plurality of Z-axis protrusions 1c which are arranged on the Z-axis surface 1z on the Z1 side to protrude from the Z-axis surface 1z. A protrusion amount of the Z-axis protrusions 1c is smaller than a protrusion amount of the Z-axis protrusions 1b. The Z-axis control boards 6z described later are connected (fastened) to the Z-axis protrusions 1c.

The sensor mount 1 is also formed of metal. Specifically, the sensor mount 1 is formed of a non-magnetic metal (e.g., aluminum alloy). In other words, the sensor mount 1 provides electromagnetic (magnetic flux) shielding.

Also, the sensor mount 1 is fixed to the base 3 by screws and the like (not shown) for fastening the sensor mount to the base 3.

The cover 4 is arranged to cover the sensor mount 1, as shown in FIG. 1. Specifically, the cover 4 has a box shape for accommodating the sensor mount 1. Specifically, the sensor mount 1 is accommodated in accommodation space defined by the cover 4 and the base 3. In other words, the cover 4, the base 3 and the connectors 8 cover the sensor mount 1 and parts that are fixed to the sensor mount 1 so that the sensor mount 1 is not exposed. Here, the sensor mount 1 may be covered by the cover 4 without the cut-out parts 4c, which will be described later, and the base 3 so that the sensor mount 1 is not exposed.

The cover 4 is formed of metal. Specifically, the cover 4 is formed of a non-magnetic metal (e.g., aluminum alloy). In other words, the cover 4 provides electromagnetic (magnetic flux) shielding.

The cover 4 is fastened to the base 3. Specifically, a flange 4a to be in surface contact with the base 3 is included on an end of the cover 4 on a base 3 side (Z2 side). The cover 4 is fixed to the base 3 by fastening the flange 4a to the base 3 by using screws 4b and the like. Also, the cover 4 has two cut-out parts 4c to expose the two connectors 8. Here, the flange 4a of the cover 4 is in contact with a surface 3a of the base 3 on the Z1 side. Also, gaskets for interrupting electromagnetic noise are arranged on boundaries between the connectors 8 and the cut-out parts 4c of the cover 4. The gaskets are formed of an electrically conductive material.

Also, the sensor apparatus 100 includes a pair of sensor sets 10. The sensor sets 10 include the gyroscopes 2 (one sensor set 10 described later), acceleration sensors 9, power supply circuits 5b, and the control boards 6 (control circuits 6b). The pair of sensor sets 10 have the same configuration as each other. The pair of sensor sets 10 are arranged side by side in a Y direction.

As shown in FIG. 2, the control board 6 includes X-axis control boards 6x, Y-axis control boards 6y, and Z-axis control boards 6z. The X-axis control board 6x and the Y-axis control board 6y are connected to each other by the wiring part 6a, and the Z-axis control board 6z and the Y-axis control board 6y are connected to each other by the wiring part 6a.

A pair of X-axis control boards 6x are attached to the pair of X-axis surfaces 1x of the sensor mount 1. A pair of Y-axis control boards 6y are attached to the pair of Y-axis surfaces 1y of the sensor mount 1. The Z-axis control boards 6z in the pair of sensor sets 10 are attached to the Z-axis surface 1z on the Z1 side in the pair of Z-axis surfaces 1z of the sensor mount 1. The two Z-axis control boards 6z attached to the Z-axis surface 1z are arranged side-by-side in the Y direction.

The X-axis control board 6x for an X1 side is arranged in a Y1-side part of the X-axis surface 1x on the X1 side. The X-axis control board 6x for an X2 side is arranged in a Y2-side part of the X-axis surface 1x on the X2 side.

In addition, the control board 6 includes a microcontroller, a power supply, and the like (not shown). The control board 6 also includes an acceleration sensor 9. Here, in FIG. 2, each acceleration sensor 9 is schematically shown.

The power supply board 5 is arranged to cover the two Z-axis control boards 6z on the Z1 side. The power supply board 5 is connected to the control boards 6 (the pair of Y-axis control boards 6y) by wiring parts 5a. Specifically, the power supply board 5 includes power supply circuits 5b (see FIG. 5) for supplying power to the control circuits 6b (see FIG. 5) included in the control boards 6 through the wiring parts 5a. The power circuits 5b also supply power to the gyroscopes 2 and acceleration sensors 9. Each of the sensor sets 10 includes the power circuit 5b and the control circuit 6b. Also, each control circuit 6b receives information (detection values) from its corresponding gyroscopes 2, its corresponding acceleration sensor 9, and the like.

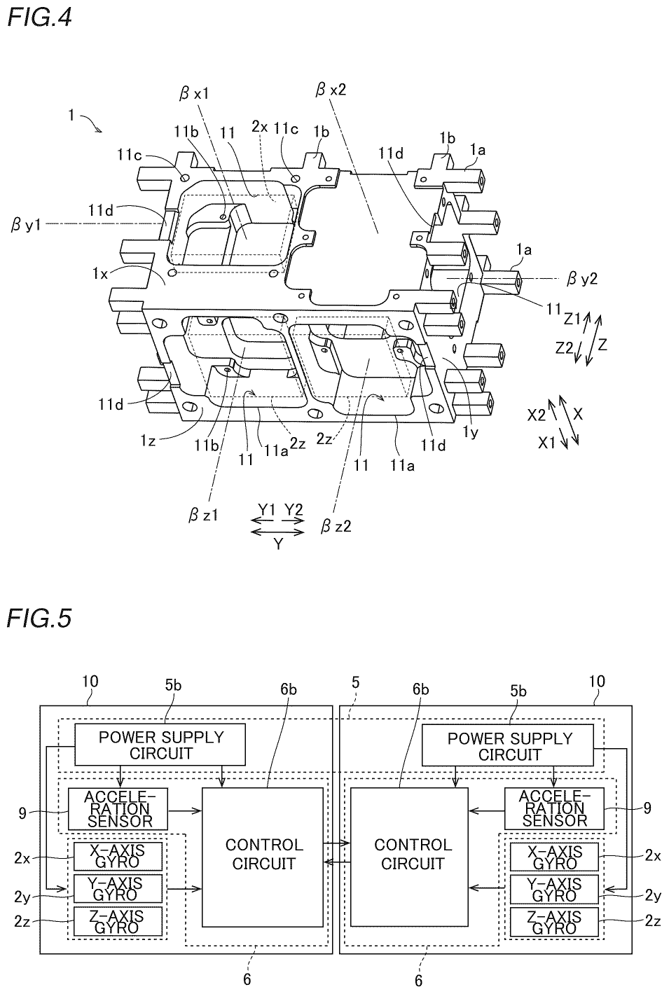

The plurality of gyroscopes 2 are arranged on the sensor mount 1 as shown in FIG. 3. The sensor mount 1 includes a plurality of recessed parts 11 in which the plurality of gyroscopes 2 are arranged. Specifically, the recessed parts 11 are arranged in the pair of X-axis surfaces 1x, the pair of Y-axis surfaces 1y, and the Z-axis surface 1z on the Z2 side of the sensor mount 1. Each of the pairs of X-axis surfaces 1x has one recessed part 11. Also, each of the pairs of Y-axis surfaces 1y has one recessed part 11. Also, the Z-axis surface 1z on the Z2 side has two recessed parts 11 as shown in FIG. 4. The two recessed parts 11 in the Z-axis surface 1z are arranged side by side in the Y direction (see FIG. 4). Also, the recessed parts 11 are opened in directions perpendicular to any surface of the sensor mount 1. Specifically, the recessed parts 11 that are arranged in the X-axis surfaces 1x are opened in directions perpendicular to the X-axis surfaces 1x. The recessed parts 11 that are arranged in the Y-axis surfaces 1y are opened in directions perpendicular to the Y-axis surfaces 1y. The recessed parts 11 that are arranged in the Z-axis surface 1z are opened in a direction perpendicular to the Z-axis surface 1z.

Each of all of the plurality of gyroscopes 2 is accommodated in corresponding one of the recessed parts 11. Specifically, the gyroscope 2 is accommodated in the recessed part 11 not to protrude from an opened end 11a of the recessed part 11.

Also, the gyroscope 2 is fixedly arranged in the recessed part 11 by screwing screws 2a provided in four corners of the gyroscope 2 to screw insertion holes 11b arranged in the recessed part 11.

The gyroscopes 2 include X-axis gyroscopes 2x, Y-axis gyroscopes 2y and Z-axis gyroscopes 2z corresponding to X, Y and Z axes, which are perpendicular to each other. The gyroscopes include two X-axis gyroscopes 2x, two Y-axis gyroscopes 2y and two Z-axis gyroscopes 2z. That is, the gyroscopes include a plurality of sensor sets 10 each of which includes the X-axis gyroscope 2x, the Y-axis gyroscope 2y and the Z-axis gyroscope 2z. Specifically, the gyroscopes include a pair of sensor sets 10. Here, one of the pair of sensor sets 10 is provided as a backup (redundant) set of sensors for another sensor set 10. Also, the X-axis gyroscopes 2x are examples of a “first-axis sensor” in the claims. Also, the Y-axis gyroscopes 2y are examples of a “second-axis sensor” in the claims. Also, the Z-axis gyroscopes 2z are examples of a “third-axis sensor” in the claims.

In this embodiment, the plurality of sensor sets 10 include at least one type of sensors that measure a common type of physical quantities. Specifically, the plurality of sensor sets 10 include the X-axis gyroscopes 2x, the Y-axis gyroscopes 2y and the Z-axis gyroscopes 2z for measuring angular velocities. Also, the plurality of sensor sets 10 include at least one type of sensors that are identical to each other in design in the sensors that measure the common type of physical quantities. Specifically, the plurality of sensor sets 10 include the X-axis gyroscopes 2x, the Y-axis gyroscopes 2y and the Z-axis gyroscopes 2z that are identical to each other in design. Here, identical in design refers that configurations of the X-axis gyroscopes 2x, the Y-axis gyroscopes 2y and the Z-axis gyroscopes 2z are completely identical to each other. That is the X-axis gyroscopes 2x, the Y-axis gyroscopes 2y and the Z-axis gyroscopes 2z are the same sensor as each other.

In this embodiment, as shown in FIG. 4, centerlines extending in a depth direction of the recessed parts 11 that are opened in the surfaces of the sensor mount 1 and paired for the pair of the X-axis gyroscopes 2x in the plurality of sensor sets 10 disagree with each other and extend in parallel to each other; centerlines extending in a depth direction of the recessed parts 11 that are opened in the surfaces of the sensor mount and paired for the pair of the Y-axis gyroscopes 2y in the plurality of sensor sets disagree with each other and extend in parallel to each other; and centerlines extending in a depth direction of the recessed parts 11 that are opened in the surface of the sensor mount and paired for the pair of the Z-axis gyroscopes 2z in the plurality of sensor sets disagree with each other and extend in parallel to each other. Specifically, centerlines βx1 and βx2 extending in a depth direction of the recessed parts 11 that are paired for the pair of the X-axis gyroscopes 2x disagree with each other and extend in parallel to each other. Centerlines βy1 and βy2 extending in a depth direction of the recessed parts 11 that are paired for the pair of the Y-axis gyroscopes 2y disagree with each other and extend in parallel to each other. Centerlines βz1 and βz2 extending in a depth direction of the recessed parts 11 that are paired for the pair of the Z-axis gyroscopes 2z disagree with each other and extend in parallel to each other.

Also, in this embodiment, the pair of sensor sets 10 are arranged on the common sensor mount 1. That is, the sensor apparatus 100 includes the single sensor mount 1 on which the pair of sensor sets 10 are commonly arranged.

Here, in this embodiment, the pair of X-axis gyroscopes 2x are arranged rotational symmetric to each other, the pair of Y-axis gyroscopes 2y are arranged rotational symmetric to each other, and the pair of Z-axis gyroscopes 2z are arranged rotational symmetric to each other with respect to a center of gravity of the sensor mount 1 as a reference. Specifically, the pair of X-axis gyroscopes 2x are arranged rotational symmetric to each other with respect to an axis line α that passes through the center of gravity of the sensor mount 1 and extends in the Z axis. Also, the pair of Y-axis gyroscopes 2y are arranged rotational symmetric to each other with respect to the axis line α, which passes through the center of gravity of the sensor mount 1 and extends in the Z axis. Also, the pair of Z-axis gyroscopes 2z are arranged rotational symmetric to each other with respect to the axis line α, which passes through the center of gravity of the sensor mount 1 and extends in the Z axis. As a result, absolute values of detection values of the pair of sensor sets 10 become the same as each other. For this reason, it is not necessary to provide an interface board for performing calculation based on the detection values of the pair of sensor sets 10. Also, since the plurality of sensor sets 10 can be arranged close to each other without interference between the plurality of X-axis gyroscopes 2x (the plurality of Y-axis gyroscopes 2y, the plurality of Z-axis gyroscopes 2z), it is possible to reduce the entire size of the sensor apparatus 100. Here, the sensor mount 1 has a rotational symmetric shape, which is rotational symmetric with respect to the axis line α. Also, the axis line α extends perpendicular to the Z axis surface 1z of the sensor mount 1. Note that “rotational symmetric” refers to a broad sense that includes not only perfect rotational symmetry but also rotational symmetry with small errors that bring the absolute values of the detection values of each pair of sensors in the sensor sets 10 in the same range. In other words, the pair of X-axis gyroscopes 2x, the pair of Y-axis gyroscopes 2y or the pair of Z-axis gyroscopes 2z may be arranged rotational asymmetric with respect to the axis line α in the sensor mount 1, which has the rotational symmetric shape with respect to the axis line α, as long as the rotational asymmetry affects the detection values of each pair of sensors in the sensor sets 10.

In detailed description, the pair of X-axis gyroscopes 2x are arranged at the same height position as each other in the Z direction. Also, the pair of X-axis gyroscopes 2x are offset from each other in the Y direction. Specifically, the X-axis gyroscope 2x on the X1 side is arranged in the recessed part 11 that is located in the Y2-side part of the X-axis surface 1x on the X1 side. Also, X-axis gyroscope 2x on the X2 side is arranged in the recessed part 11 that is located in the Y1-side part of the X-axis surface 1x on the X2 side.

Also, the pair of Y-axis gyroscopes 2y are arranged at the same height position as each other in the Z direction. Also, the pair of Y-axis gyroscopes 2y are offset from each other in the X direction. Specifically, the Y-axis gyroscope 2y on the Y1 side is arranged in the recessed part 11 that is located in the X1-side part of the Y-axis surface 1y on the Y1 side. The Y-axis gyroscope 2y on the Y2 side is arranged in the recessed part 11 that is located in the X2-side part of the Y-axis surface 1y on the Y2 side.

Also, the pair of Z-axis gyroscopes 2z are arranged at the same height position as each other in the Z direction. Also, the pair of Z-axis gyroscopes 2z are offset from each other in the X direction. The Z-axis gyroscope 2z on the Y1 side is arranged in the recessed part 11 that is located closer to the X1 side in the Z-axis surface 1z on the 22 side. The Z-axis gyroscope 2z on the Y2 side is arranged in the recessed part 11 that is located closer to the X2 side in the Z-axis surface 1z on the Z2 side.

Here, since the pair of sensor sets 10 are arranged rotational symmetric to each other, polarity of the detection values of each pair of sensors in the sensor sets 10 are opposite to each other. The control boards 6 (control circuits 6b) adjust the detection values of each pair of sensors in the sensor sets 10 to their positive or negative values. Specifically, the control circuits 6b receive measurement results from both the paired gyroscopes 2, and execute control of reversing polarity of measured values included in one of the measurement results and control of not reversing polarity of measured values included in another of the measurement results. Also, since the pair of sensor sets 10 are arranged rotational symmetric to each other, the pair of control boards 6 can have a common configuration. In other words, the pair of control boards have the common configuration in terms that each of the pair of control boards 6 includes the X-axis control board 6x, the Y-axis control board 6y, and the Z-axis control board 6z. The control boards 6b are examples of a “controller” in the claims.

Also, in this embodiment, the pair of X-axis gyroscopes 2x are arranged in the recessed parts 11 in the pair of X-axis surfaces 1x, which are arranged on sides opposite to each other. Also, the pair of Y-axis gyroscopes 2y are arranged in the recessed parts 11 in the pair of Y-axis surfaces 1y, which are arranged on sides opposite to each other. That is, the gyroscopes 2 (2x, 2y) are arranged on their corresponding one of four side surfaces (1x, 1y) of the sensor mount 1.

The Z-axis gyroscopes 2z are arranged in their corresponding one of the two recessed parts 11 in the Z-axis surface 1z on the Z2 side. Here, no recessed part 11 is arranged on the Z-axis surface 1z on the Z1 side.

The plates 7 are arranged between the recessed parts 11 and the cover 4, and are arranged to cover the recessed parts 11 so as not to expose the gyroscopes 2 arranged in the recessed parts 11 of the sensor mount 1. Specifically, the plates 7 are arranged to overlap the entire recessed parts 11. Also, each plate 7 is fixed to the sensor mount 1 by inserting screws 7a arranged in four corners of the plate 7 into screw insertion holes 11c arranged outside corresponding one of recessed parts 11.

Also, the plates 7 provide electromagnetic noise shielding. Specifically, the plates 7 are formed of metal. In detailed description, the plates 7 are formed of a non-magnetic metal (e.g., aluminum alloy).

Also, each plate 7 has a plate-like shape extending in corresponding one of the pair of X-axis surfaces 1x or corresponding one of the pair of Y-axis surfaces 1y of the sensor mount 1. Specifically, each plate 7 is formed in a square shape. The plate 7 is attached to the Y2-side part of the X-axis surface 1x on the X1 side, which is formed in a rectangular shape. Also, the plate 7 is attached to the Y1-side part of the X-axis surface 1x on the X2 side, which is formed in a rectangular shape.

The plates 7 include the X-axis plates 7x covering the recessed parts 11 arranged in the X-axis surfaces 1x, and the Y-axis plates 7y covering the recessed parts 11 arranged in the Y-axis surfaces 1y. The X-axis plates 7x are arranged side by side adjacent to the X-axis control boards 6x in the Y direction without overlapping the X-axis control boards 6x (see FIG. 1). The Y-axis plates 7y are arranged to overlap the Y-axis control boards 6y (see FIGS. 1 and 2).

Each Y-axis plate 7y has a plurality of cut-out parts 7b avoiding the Y-axis protrusions 1a of the sensor mount 1. Each X-axis plate 7x has no cut-out part.

Also, the base 3 (see FIG. 1) is arranged to cover the recessed parts 11 (see FIG. 4) arranged in the Z-axis surface 1z on the Z2 side. Specifically, the base 3 is arranged to cover the entire surface of the Z-axis surface 1z on the Z2 side. That is, the two recessed parts 11 in which the two Z-axis gyroscopes 2z are arranged are covered by the common (single) base 3 in the Z-axis surface 1z.

Also, the base 3 provides electromagnetic noise shielding. Specifically, the base 3 is formed of metal. In detailed description, the base 3 is formed of a non-magnetic metal (e.g., aluminum alloy). That is, the cover 4, the plates 7, the sensor mount 1, and the base 3 are formed of the same material.

Also, a thickness t1 of the base 3 (see FIG. 1) is greater than a thickness t2 of the cover 4 (see FIG. 1). Specifically, the thickness t1 of the base 3 is not smaller than twice (e.g., triple) the thickness t2 of the cover 4.

Also, the thickness t1 of the base 3 (see FIG. 1) is greater than a thickness t3 of the plate 7 (see FIG. 3). Specifically, the thickness t1 of the base 3 is not smaller than twice (e.g., triple) a thickness t3 of the plate 7. Here, no plate for shielding against electromagnetic noise is arranged between the base 3 and the Z-axis gyroscopes 2z. In other words, the base 3 and each Z-axis gyroscope 2z are arranged to face each other without the plate between them. The Z-axis gyroscope 2z is enclosed between each recessed part 11 and the base 3 to shield the Z-axis gyroscope 2z against electromagnetic noise.

The gyroscopes 2 (2x to 2z) include sensor main bodies 2b, and the connection wiring parts 2c connecting the sensor main bodies 2b to the control boards 6 (Y-axis control boards 6y). The gyroscopes 2 and the control board 6 (Y-axis control board 6y) that are included in the sensor set 10 common to each other are connected by the connection wiring parts 2c.

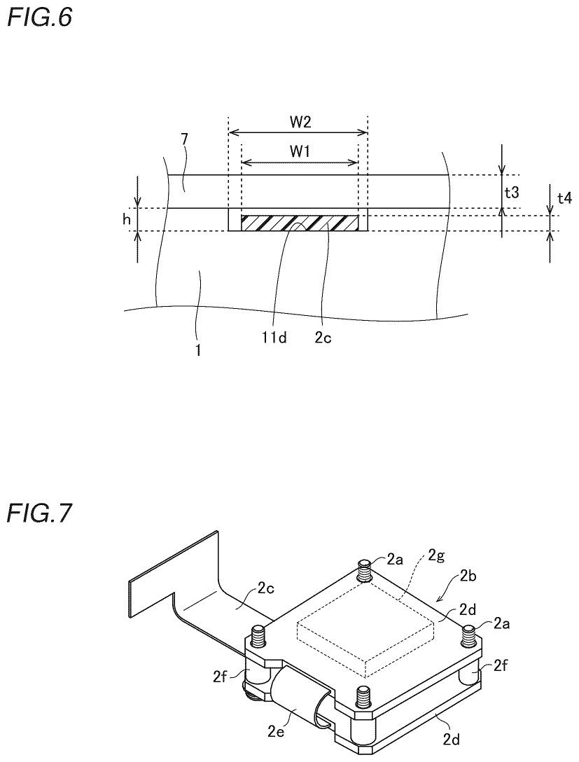

The recessed parts 11 of the sensor mount 1 include cut-out parts 11d through which the connection wiring parts 2c are drawn out. The cut-out parts 11d are arranged in the opened ends 11a of the recessed parts 11. In other words, the connection wiring parts 2c are drawn out through the cut-out parts 11d with recessed part 11 being covered by the plates 7 (base 3) (see FIG. 6). Here, the cut-out parts 11d may be arranged in the plates 7 or in both the recessed parts 11 and the plates 7.

As shown in FIG. 6, the connection wiring parts 2c have the thickness t3 (e.g., 0.8 mm). The cut-out parts 11d have a depth h (e.g., 1 mm) greater than the thickness t3. Also, the connection wiring parts 2c have a width W1. Also, the cut-out parts 11d have a width W2 greater than the width W1. Here, the plurality of cut-out parts 11d have the same size as each other.

Also, the connection wiring parts 2c of the gyroscope 2 include flexible cables. In other words, the connection wiring parts 2c have flexibility (softness). The connection wiring parts 2c are formed of polyimide, for example. The connection wiring parts 2c include flexible cables so that the flexible cables can absorb shock even if vibration occurs. As a result, it is possible to prevent disconnection of the connection wiring parts 2c from the control boards 6. Also, since the connection wiring parts 2c include flexible cables, it is possible to bend the connection wiring parts 2c at an angle that can easily draw out the connection wiring parts in the recessed parts 11 through the cut-out parts 11d. Accordingly, even if a clearance between the cut-out part 11d and the connection wiring part 2c is reduced, it is possible to easily draw out the connection wiring part 2c through the cut-out part 11d. Since the aforementioned clearance can be reduced, it is possible to increase a frequency range of electromagnetic noise shielding provided by the plates 7 and the base 3 to a wider range (increase an upper limit on a high frequency side).

The connection wiring parts 2c, which extend from the X-axis gyroscope 2x, the Y-axis gyroscope 2y and the Z-axis gyroscopes 2z in each of the pair of sensor sets 10, are connected to the Y-axis control boards 6y with being bent (deformed).

Also, the gyroscope 2 includes a rigid flexible substrate, as shown in FIG. 7. The rigid flexible board refers to a board including rigid and flexible parts. The sensor main body 2b includes two rigid parts 2d, and a flexible part 2e connecting the rigid parts 2d to each other. The two rigid parts 2d are arranged to face each other by bending the flexible part 2e. Here, the connection wiring part 2c extends from one of the two rigid parts 2d. Also, the flexible part 2e is formed of the same material (i.e., polyimide) as the connection wiring part 2c.

Also, the sensor main body 2b includes spacers 2f arranged between a pair of rigid parts 2d arranged to face each other. Predetermined space is formed between the two rigid parts 2d by the spacer 2f. The spacers 2f are arranged in four corners of each rectangular (square) rigid part 2d. Also, the spacers 2f have a cylindrical shape. The screws 2a are arranged to pass through the spacers 2f having the cylindrical shape. Dotted lines in FIG. 7 represent a sensor head 2g. The sensor head 2g is an electromagnetic type sensor head using MEMS technology, for example. Also, the sensor head 2g may be a piezoelectric or electrostatic type sensor head.

### Advantages of the Embodiment

In this embodiment, the following advantages are obtained.

In this embodiment, as described above, the sensor apparatus 100 is configured including a common sensor mount 1 to which the plurality of sensor sets 10 are provided. Accordingly, it possible to reduce the number of parts of the sensor apparatus 100, and to prevent a configuration of the sensor apparatus 100 from becoming complicated as compared to a case in which the sensor mounts 1 corresponding to the plurality of sensor sets 10 are provided separately from each other.

Also, in a case in which a plurality of sensor mounts 1 are provided, a gap is necessarily provided between the sensor mounts 1 to prevent interference of the sensor mounts 1. Contrary to this, in the case in which the plurality of sensor sets 10 are provided to the common sensor mount 1, the aforementioned gap can be omitted so that an installation (arrangement) area of the common sensor mount 1 can be reduced.

Also, in the case in which the sensor mounts 1 corresponding to the plurality of sensor sets 10 are provided separately from each other, position misalignment between the sensor mounts 1 may occur. In this case, the misalignment between the sensor sets 10 may be large. From this viewpoint, no position misalignment between the sensor mounts 1 occurs in a case of the common sensor mount 1 to which the plurality of sensor sets 10 are provided, and as a result, it is possible to prevent the position misalignment between the sensor sets 10. Consequently, it is possible to reduce difference between detection results of the sensor sets 10 caused by the aforementioned position misalignment.

In this embodiment, as described above, the sensor mount 1 has a polyhedral shape; the sensor mount 1 includes recessed parts 11 for arranging all of the sensors that are arranged symmetric with respect to the center of gravity; and the recessed parts 11 are opened in directions perpendicular to any surface of the sensor mount 1. Accordingly, a protrusion amount of the gyroscope 2 from the sensor mount 1 can be reduced by at least a depth of the recessed part 11 by arranging the gyroscope 2 in the recessed part 11. Consequently, it is possible to further reduce size of the sensor apparatus 100.

In this embodiment, as described above, all of the X-axis gyroscopes 2x, all of the Y-axis gyroscopes 2y, and all of the Z-axis gyroscopes 2z are arranged in the recessed parts 11 of the sensor mount 1. Accordingly, by arranging all of the gyroscopes 2 in the recessed part 11, protrusion amounts of the gyroscopes 2 from the sensor mount 1 can be reduced by at least a depth of the recessed part 11. Consequently, it is possible to further reduce size of the sensor apparatus 100.

In this embodiment, as described above, the control circuits 6b receive measurement results from both the paired gyroscopes 2, and execute control of reversing polarity of measured values included in one of the measurement results and control of not reversing polarity of measured values included in another of the measurement results. Accordingly, even if an abnormality occurs in one of the pair of gyroscopes 2, a detection value of another of the pair of gyroscopes 2 can be used.

In this embodiment, as described above, the sensor apparatus 100 is configured including the pair of X-axis gyroscopes 2x identical to each other in design (the pair of Y-axis gyroscopes 2y identical to each other in design, the pair of Z-axis gyroscopes 2z identical to each other in design) being arranged rotational symmetric to each other with respect to an axis line x that passes through the center of gravity of the sensor mount 1 and extends in a predetermined direction. Accordingly, since absolute values of detection values of the X-axis gyroscopes 2x can be the same, even if an abnormality occurs in one of the pair of X-axis gyroscopes 2x, a detection value of another of the pair of X-axis gyroscopes 2x can be used. The Y-axis gyroscopes 2y and the Z-axis gyroscopes 2z have an advantage similar to the X-axis gyroscopes 2x.

In this embodiment, as described above, the axis line x extends perpendicular to the Z-axis surface 1z of the sensor mount 1. Accordingly, the X-axis gyroscope 2x can be easily arranged symmetric with respect to the axis line x extending perpendicular to the Z-axis surface 1z of the sensor mount 1. The Y-axis gyroscopes 2y and the Z-axis gyroscopes 2z have an advantage similar to the X-axis gyroscopes 2x.

In this embodiment, as described above, the pair of X-axis gyroscopes 2x are arranged in the pair of X-axis surfaces 1x, which are arranged on sides opposite to each other, of the sensor mount 1; and the pair of Y-axis gyroscopes 2y are arranged in the pair of Y-axis surfaces 1y, which are arranged on sides opposite to each other; and the pair of Z-axis gyroscope 2z are arranged in a common Z-axis surface 1z of the sensor mount 1. Accordingly, it is possible to easily reduce areas of the pair of X-axis surfaces 1x in which the pair of X-axis gyroscopes 2x are arranged and the pair of Y-axis surfaces 1y in which the pair of Y-axis gyroscopes 2y are arranged as compared with a case in which all of the pairs of X-axis gyroscopes 2x, Y-axis gyroscopes 2y, and Z-axis gyroscopes 2z are arranged in their common surfaces.

Consequently, it is possible to easily reduce size of the sensor mount 1 (sensor apparatus 100). Also, dissimilar to a case where the pair of Z-axis gyroscopes 2z are arranged in opposite-side surfaces of the sensor mount 1, the gyroscopes 2 are not arranged on a surface opposite to the Z-axis surface 1z. Accordingly, it is possible to easily arrange a part (board, wiring part, or the like) other than the gyroscopes 2 in a surface opposite to the Z-axis surface 1z. As a result, while reducing the size of sensor mount 1 (sensor apparatus 100), it is possible to easily place components other than gyroscope 2 (board or wiring, etc.) on sensor mount 1.

In this embodiment, as described above, the sensor apparatus 100 is configured including the sensors including the gyroscopes 2. Here, the gyroscopes 2 are relatively large sensors as compared with, for example, acceleration sensors. For this reason, in the case in which the sensor mounts 1 corresponding to the plurality of sensor sets 10 are provided separately from each other, a plurality of relatively large sensor mounts 1 are provided. From this viewpoint, in a case in which the sensors include gyroscopes 2, prevention of increase of the number of sensor mounts 1 by arranging the plurality of sensor sets 10 in the common sensor mount 1 part is particularly effective at reducing size of the sensor apparatus 100.

### Modified Embodiments

Note that the embodiment disclosed this time must be considered as illustrative in all points and not restrictive. The scope of the present invention is not shown by the above description of the embodiments but by the scope of claims for patent, and all modifications (modified embodiments) within the meaning and scope equivalent to the scope of claims for patent are further included.

While the example in which a pair of sensor sets 10 are arranged in the common sensor mount 1 (sensor arrangement part) has been shown in the aforementioned embodiment, the present invention is not limited to this. Three or more sensor sets 10 may be arranged in the sensor mount 1.

While the example in which a plurality of sensor sets 10 including a plurality of types of gyroscopes 2 (sensors) are arranged in the sensor mount 1 has been shown in the aforementioned embodiment, the present invention is not limited to this. For example, a plurality of sensor sets 10 including a sensor (e.g., an acceleration sensor 9 or a temperature sensor) other than the gyroscope 2 may be arranged in the sensor mount 1.

While the example in which one gyroscope 2 measures physical quantity acting in one direction has been shown in the aforementioned embodiment, the present invention is not limited to this. For example, one gyroscope 2 may measure a physical quantities acting in a plurality of directions.

While the example in which one gyroscope 2 is arranged in one recessed part 11 has been shown in the aforementioned embodiment, the present invention is not limited to this. For example, a plurality of gyroscopes 2 may be arranged in one recessed part 11.

While the example in which each of the sensor mount 1 (sensor arrangement part), plates 7, and the base 3 is formed of metal has been shown in the aforementioned embodiment, the present invention is not limited to this. For example, any of the sensor mount 1, the plates 7 and the base 3 may be formed of non-magnetic ceramics or a non-magnetic resin. From the viewpoint of heat dissipation, the sensor mount 1, the plates 7, and the base 3 are preferably formed of metal.

Also, although it has been illustratively described in the aforementioned embodiment that the sensor mount 1, the plates 7, and the base 3 are separate parts, two or more of these parts may be integrally formed as a unitary part. Also, the sensor mount 1 may include two or more parts as long as no problem arises in terms of degree of positioning accuracy between the gyroscopes 2 in each sensor set 10 or between gyroscopes 2 included in the sensor sets 10. Each of the plates 7 or the base 3 may also include two or more parts.

Also, although it has been illustratively described in the aforementioned embodiment that the sensor mount 1, the plates 7, and the base 3 are separate parts, it is only required to carry out all of functions stated in the claims with the sensor apparatus 100 being assembled, and any function is not necessarily realized solely by the sensor mount 1, each plate 7, or the base 3. Also, the sensor mount 1, the plates 7, and the base 3 may transfer, exchange or share some of the functions stated in the claims between them.

While the example in which the sensor mount 1 (sensor arrangement part) has a rectangular parallelepiped shape has been shown in the aforementioned embodiment, the present invention is not limited to this. The sensor mount 1 may have a shape (e.g., cubic shape) other than the rectangular parallelepiped shape. The sensor mount 1 will have a rounded part, stepped part, protrusion, recessed part, through-hole, or the like, and does not necessarily have an exact rectangular parallelepiped shape.

While the example in which a pair of Z-axis gyroscope 2z (third-axis sensors) are arranged in a common Z-axis surface 1z (third surface) of the sensor mount 1 (sensor arrangement part) has been shown in the aforementioned embodiment, the present invention is not limited to this. The pair of Z-axis gyroscopes 2z may be arranged in the Z-axis surfaces 1z, which are arranged on sides opposite to each other. Also, a pair of X-axis gyroscopes 2x (first-axis sensors) may be arranged in a common X-axis surface 1x (first surface). Also, a pair of Y-axis gyroscopes 2y (second-axis sensors) are arranged in a common Y-axis surface 1y (second surface). A plurality of gyroscopes may be arranged in each of both the X-axis surfaces 1x facing each other (Y-axis surfaces 1y facing each other, Z-axis surfaces 1z facing each other).

While the example in which a pair of sensor sets 10 are arranged symmetric with respect to an axis line x that extends in the Z axis (third axis) has been shown in the aforementioned embodiment, the present invention is not limited to this. Two sensor sets 10 may be arranged rotational symmetric with respect to an axis line x that passes through a center of gravity of the sensor mount 1 (sensor arrangement part) and extends in the X axis (first axis) or the Y axis (second axis).

While the example in which paired gyroscopes 2 are rotational-symmetrically arranged and face each other so that polarities of their detection values are opposite to each other has been shown in the aforementioned embodiment, the present invention is not limited to this. For example, the paired gyroscopes 2 in the recessed parts 11 may face in the same direction so that polarities of their detection values are not opposite to each other.

While the example in which the gyroscope 2 (sensor) is arranged in the recessed part 11 of the sensor mount 1 (sensor arrangement part) has been shown in the aforementioned embodiment, the present invention is not limited to this. The gyroscopes 2 may be provided to the sensor mount 1 without any recessed part 11.

### DESCRIPTION OF REFERENCE NUMERALS

1; sensor mount (sensor arrangement part)
1x; X-axis surface (first surface) (pair of surfaces)
1y; Y-axis surface (second surface) (pair of surfaces)
1z; Z-axis surface (third surface) (bottom surface)
2; gyroscope (sensor)
2x; X-axis gyroscope (first-axis sensor)
2y; Y-axis gyroscope (second-axis sensor)
2z; Z-axis gyroscope (third-axis sensor)
6b; control circuit (controller)
10; sensor set
11; recessed part
100; sensor apparatus
X; axis (first axis)
Y; axis (second axis)
Z; axis (third axis)
α; axis line

What is claimed is:

1. A sensor apparatus comprising:
a plurality of sensor sets, each set including a plurality of different types of sensors; and
a common sensor arrangement part to which the plurality of sensor sets are arranged, wherein
the sensor arrangement part comprises an integral part formed of a single material;
the plurality of sensor sets include at least one type of sensors that measure a common type of physical quantities and are identical to each other in design, and
the at least one type of sensors that are identical to each other in design are arranged symmetric with respect to a center of gravity of the sensor arrangement part.

2. The sensor apparatus according to claim 1, wherein
the sensor arrangement part has a polyhedral shape;
the sensor arrangement part includes recessed parts for arranging all of the at least one type of sensors that are arranged symmetric with respect to the center of gravity; and
the recessed parts are opened in directions perpendicular to any surface of the sensor arrangement part.

3. The sensor apparatus according to claim 2, wherein
each of the plurality of sensor sets includes corresponding first-axis sensors, corresponding second-axis sensors and corresponding third-axis sensors corresponding a first axis, a second axis and a third axis, respectively, perpendicular to each other as sensors that are arranged symmetric with respect to the center of gravity;
the sensor arrangement part has a rectangular parallelepiped shape; and
all of the first-axis sensors, all of the second-axis sensors, and all of the third-axis sensors are arranged in the recessed parts of the sensor arrangement part.

4. The sensor apparatus according to claim 1, further comprising a controller, wherein
the first-axis sensors, the second-axis sensors and the third-axis sensors included in the plurality of sensor sets include at least one pair of sensors that are paired to face each other; and
the controller receives measurement results from both the pair of sensors, and executes control of reversing polarity of measured values included in one of the measurement results and control of not reversing polarity of measured values included in another of the measurement results.

5. The sensor apparatus according to claim 4, wherein
at least one pair of the first-axis sensors are arranged rotational symmetric with respect to an axis line that passes through the center of gravity of the sensor arrangement part and extends in a predetermined direction;
at least one pair of the second-axis sensors are arranged rotational symmetric with respect to the axis line, which passes through the center of gravity of the sensor arrangement part and extends in the predetermined direction; and
at least one pair of the third-axis sensors are arranged rotational symmetric with respect to the axis line, which passes through the center of gravity of the sensor arrangement part and extends in the predetermined direction.

6. The sensor apparatus according to claim 5, wherein the axis line extends perpendicular to a bottom surface of the sensor arrangement part.

7. The sensor apparatus according to claim 6, wherein
the pair of first-axis sensors are arranged on each of a pair of first surfaces on sides of the sensor arrangement part opposite to each other;
the pair of second-axis sensors are arranged on each of a pair of second surfaces on sides of the sensor arrangement part opposite to each other; and
the pair of third-axis sensors are arranged on common third surface of the sensor arrangement part.

8. The sensor apparatus according to claim 7, wherein centerlines extending in a depth direction of the recessed parts that are opened in the surfaces of the sensor arrangement part and paired for the pair of the first-axis sensors in the plurality of sensor sets disagree with each other and extend in parallel to each other; centerlines extending in a depth direction of the recessed parts that are opened in the surfaces of the sensor arrangement part and paired for the pair of the second-axis sensors in the plurality of sensor sets disagree with each other and extend in parallel to each other; and centerlines extending in a depth direction of the recessed parts that are opened in the surface of the sensor arrangement part and paired for the pair of the third-axis sensors in the plurality of sensor sets disagree with each other and extend in parallel to each other.

9. The sensor apparatus according to claim 3, wherein the first-axis sensors, second-axis sensors and third-axis sensors are gyroscopes.
